(19) United States
(12) Patent Application Publication
(10) Pub. No.: US 2011/0068492 A1
(43) Pub. Date: Mar. 24, 2011

(54) 3D CURVED DISPLAY DEVICES, FABRICATION METHODS THEREOF AND PLASTIC DISPLAY PANELS

(75) Inventors: Janglin Chen, Kaohsiung County (TW); Ar-Fu Lam, Hsinchu City (TW); Tzeng-Shii Tsai, Hsinchu County (TW)

(73) Assignee: INDUSTRIAL TECHNOLOGY RESEARCH INSTITUTE, Hsinchu (TW)

(21) Appl. No.: 12/775,366

(22) Filed: May 6, 2010

(30) Foreign Application Priority Data
Sep. 22, 2009 (TW) TW098131891

(51) Int. Cl. B29D 11/00; G02F 1/1333

(52) U.S. Cl. 264/1.7; 349/84

(57) ABSTRACT

A 3D curved display device, fabrication method thereof and a plastic display panel are provided. The method includes providing a plastic display panel. The plastic display panel includes a first electrode layer formed on a first substrate, a second electrode layer formed on a second substrate, and a plurality of spacers and a display medium layer disposed between the first and the second electrode layers. A pressure source and a mold are provided to sandwich the plastic display panel to perform a molding process to form a 3D curved display device, wherein the first and the second substrates, and the first and the second electrode layers are made of plastic or elastic materials and the display medium layer is plastic, having a thickness greater than a height of the spacer before the molding process.

### CROSS REFERENCE TO RELATED APPLICATIONS

This Application claims priority of Taiwan Patent Application No. 98131891, filed on Sep. 22, 2009, the entirety of which is incorporated by reference herein.

### BACKGROUND OF THE INVENTION

1. Field of the Invention

The invention relates to a display device and more particularly to a 3D curved display device and a fabrication method thereof.

2. Description of the Related Art

Recently, flexible display devices have been used for curved display effect to enhance viewing pleasure of users, along with other conventional display devices. Most conventional curved display devices are two-dimensional (2D) curved displays. For example, a display panel may be formed from glass substrate processed to form a curved display with a small curvature or a display panel may be formed from plastic substrates to enhance display curvature.

US Publication No. 2008/0151089A1 discloses a semi-sphere type image sensor, which is fabricated by forming several element segments in a substrate, wherein the element segments are arranged together. While the semi-sphere type image sensor may be applied in display devices, smooth curves for viewing cannot be achieved due to the intersecting areas. Also, display quality is poor.

Meanwhile, International Patent No. WO 2006/035786A1 discloses a tensible array element. A plurality of sensors is fabricated on nodes of a meshed flexible substrate, such that a tensible character is provided and the sensors at the nodes and the signal lines of the array element are not deformed when stressed. However, the meshed flexible substrate needs a large empty area. Thus, the tensible array element is not suitable for display devise requiring a large area for pixel electrodes.

The above mentioned devices for fabricating curved elements can not achieve display devices with 3D curved effect. Therefore, a 3D curved display device and fabrication methods thereof are desired to achieve a stereo-image display effect and increased display device applications.

### BRIEF SUMMARY OF THE INVENTION

The invention provides a method for forming a 3D curved display device. First, a first substrate is provided and then a first electrode layer is formed on the first substrate. A plurality of spacers is formed on the first electrode layer. A display medium layer is formed over the first substrate, covering the spacers and the first electrode layer. Then, a second electrode layer is formed on the display medium layer. A first mold and a pressure source are provided to sandwich the first substrate to the second electrode layer. Then, a molding process is performed to compress the first substrate, the first electrode layer, the spacers, the display medium layer and the second electrode layer to form a 3D curved display device, wherein the first substrate, the first electrode layer and the second electrode layer are made of plastic or elastic materials, and the display medium layer has a first thickness before the molding process. The first thickness is greater than a height of the spacers.

The invention further provides another method for forming a 3D curved display device. First, a first mold is provided and a first electrode layer is formed on the first mold. Then, a first substrate is provided and a second electrode layer is formed on the first substrate. A plurality of spacers is formed on the second electrode layer. A display medium layer is formed on the spacers and the second electrode layer. A pressure source is disposed over the first substrate. Then, a molding process is performed to compress the first substrate, the second electrode layer, the spacers, the display medium layer and the first electrode layer to form a 3D curved display device, wherein the first substrate, the first electrode layer and the second electrode layer are made of plastic or elastic materials, and the display medium layer has a first thickness before the molding process. The first thickness is greater than a height of the spacers.

The invention further provides a 3D curved display device. The 3D curved display device comprises a first substrate. A first electrode layer is disposed on the first substrate. A display medium layer is disposed over the first electrode layer. A plurality of spacers is disposed in the display medium layer. In addition, a second electrode layer is disposed on the display medium layer. In the 3D curved display device, the first substrate, the first electrode layer and the second electrode layer are made of plastic or elastic materials, and the display medium layer has a thickness equal to a height of the spacers.

The invention further provides a plastic display panel. The plastic display panel comprises a first substrate. A first electrode layer is disposed on the first substrate. A plurality of spacers is disposed on the first electrode layer. A display medium layer is disposed over the spacers and the first electrode layer. A second electrode layer is disposed on the display medium layer. A second substrate disposed on the second electrode layer. A protection layer or a releasing layer is optionally disposed on the second electrode layer before the second substrate is disposed. In the plastic display panel, the first substrate, the first electrode layer and the second electrode layer are made of plastic or elastic materials, and the display medium layer has a thickness equal to a height of the spacers.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIGS. 1A-1D show schematic cross sections of a method for fabricating a 3D curved display device according to an embodiment of the invention;

FIGS. 2A-2E show schematic cross sections of a method for fabricating a 3D curved display device according to another embodiment of the invention;

FIGS. 3A-3D show schematic cross sections of a method for fabricating a 3D curved display device according to further another embodiment of the invention; and

FIGS. 4A-4C show schematic cross sections of a method for fabricating a 3D curved display device according to further another embodiment of the invention.

### DETAILED DESCRIPTION OF THE INVENTION

The following description is of the contemplated mode of carrying out the invention. The description is provided for illustrating the general principles of the invention and is not meant to be limiting. The scope of the invention is best determined by reference to the appended claims.

An embodiment of the invention utilizes plastic or elastic materials as substrates and electrode layers of displays. In addition, a plastic display medium layer is disposed between an upper substrate and a lower substrate and also between an upper electrode layer and a lower electrode layer. The display medium layer includes a plurality of display medium microcapsules and a polymer filled between the display medium microcapsules, wherein the polymer may be curable resin. The above mentioned materials are compressed at a suitable temperature and a suitable pressure in a molding process and then treated by a curing process to form a 3D curved display device.

The 3D curved display device of an embodiment of the invention can display 3D images in 3 directions, i.e. x, y and z directions. A curved stereo-shape of the 3D curved display device matchs a surface stereo-shape of a mold used for the molding process, such that the 3D curved display device can have any 3D curved shape, such as a concave shape, a convex shape or a complex curved surface composed of concave and convex shapes. The 3D curved display device can be for example a face mold of a doll which can change images, a utensil surface which can change patterns and colors or can be applied to medical treatment for displaying stereo-structures of the human body, for example a head or an organ in the cranium.

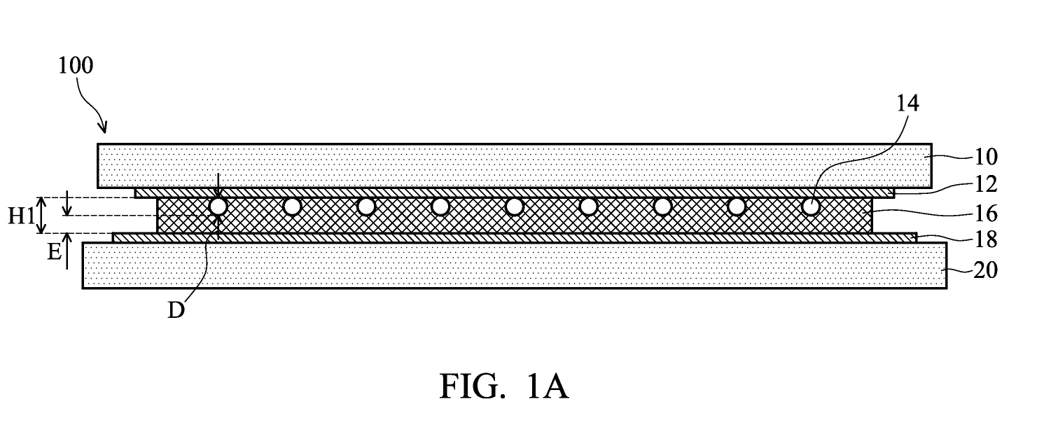

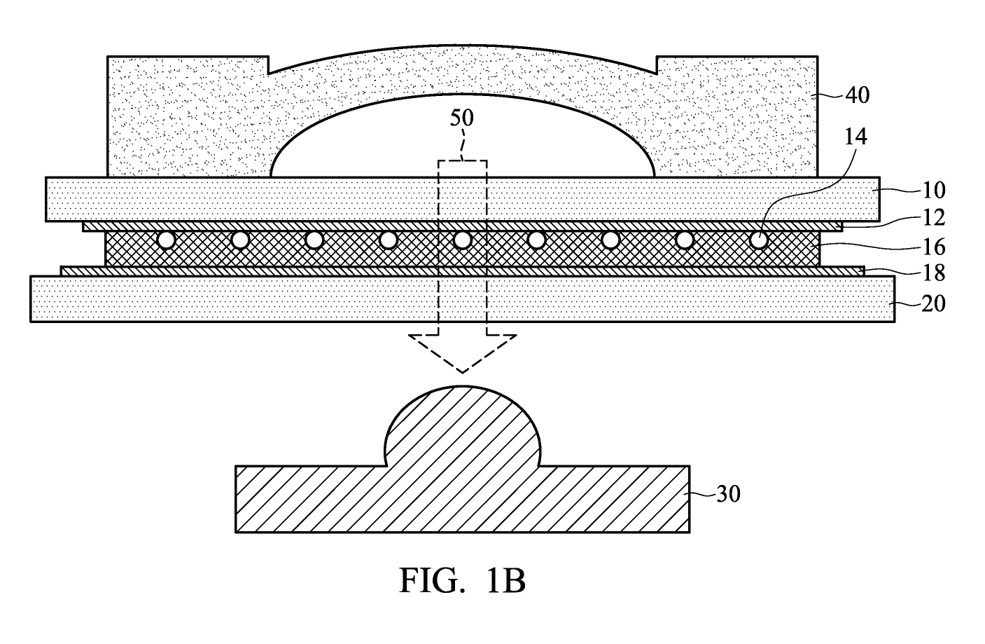

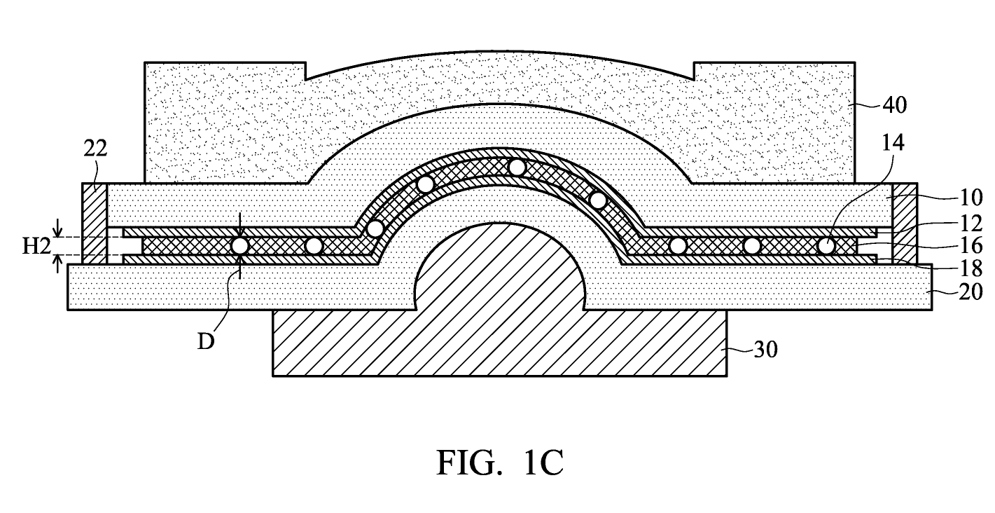

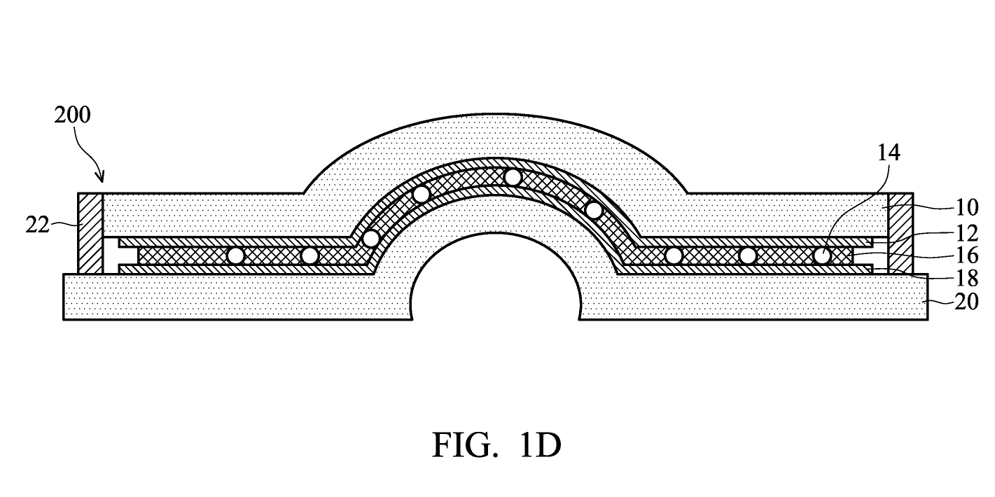

Referring to FIGS. 1A-1D, cross sections of a method for fabricating a 3D curved display device according to an embodiment of the invention are shown. As shown in FIG. 1A, first a plastic display panel 100 is provided. The plastic display panel 100 includes an upper substrate 10 and an upper electrode layer 12 is formed on the upper substrate 10. A lower substrate 20 is disposed opposite to the upper substrate 10 and a lower electrode layer 18 is formed on the lower substrate 20. A plurality of spacers and a display medium layer 16 are formed between the upper electrode layer 12 and the lower electrode layer 18. The display medium layer 16 has a thickness H1 greater than a height D of the spacers. In an embodiment, the difference E between the thickness H1 and the height D is about 0.3 to 0.5 times the height D, i.e. the thickness H1 is about 1.3 to 1.5 times the height D.

The upper substrate 10 and the lower substrate 20 may be plastic or elastic materials, for example poly(ethylene terephthalate) (PET), poly(ether sulfone) (PES), poly(ethylene 2,6-naphthalate) (PEN), poly carbonate (PC), polyimide (PI), poly(phenylene sulfone) (PPSU), natural rubber, silicone, or polyurethane (PU), or the derivatives based on the above mentioned materials or combinations of the above mentioned materials.

In an embodiment, the upper substrate 10 and/or the lower substrate 20 may be a transparent substrate.

The upper electrode layer 12 and the lower electrode layer 18 may be plastic or elastic materials, for example poly(3,4-ethylene dioxythiophene) (PEDOT), polyaniline (PANI), mixtures of polymer with nano-carbon tubes (CNTs) or mixtures of polymer with metal fibers. Compared with the material of the general transparent electrode layer, i.e. indium tin oxide (ITO), the materials of the upper electrode layer 12 and the lower electrode layer 18 can permit greater deformation. Moreover, the upper electrode layer 12 and the lower electrode layer 18 can be patterned electrode layers.

The spacers 14 may be ball spacers or photo spacers, which can be formed by a spraying or a photolithography process. The display medium layer 16 may include a plurality of microcapsules, having a display medium with a variable optical status in the microcapsule, and a plastic polymer material filling between the microcapsules. The plastic polymer material may be a curiable resin, which can be cured by a heat curing process or a UV light curing process. The display medium layer 16 may be an electro-phoretic display (EPD) medium layer, a cholesteric liquid crystal display (ChLCD) medium layer, an electrowetting display (EWD) medium layer or a quick-response liquid power display (QR-LPD) medium layer.

Driving methods for display pixels of the 3D curved display devices may comprise an electrical driving method, including a direct driving (or segmented driving) method, a passive matrix driving method and an active matrix driving method, or a photo driving method or a thermal driving method. In an embodiment, a thin film transistor (TFT) array (not shown) is further formed on the lower substrate 20. The TFT array is electrically connected to the lower electrode layer 18 of the lower substrate 20 to form an active-matrix (AM) typed display.

Then, referring to FIG. 1B, a pressure source is provided over the upper substrate 10. In an embodiment, the pressure source can be provided from a mold 40 over the upper substrate 10. Meanwhile, a mold 30 is provided under the lower substrate 20. Through a molding process 50 to control a temperature, a tension and a pressure suitable for the plastic display panel 100, the plastic display panel 100 is compressed onto the mold 30, as shown in FIG. 1C. After the molding process, the display medium layer 16 has a thickness H2 substantially equal to the height D of the spacers 14. Then, the display medium layer 16 is cured for shaping by a heat curing process or a UV light curing process.

In an embodiment, a sealant 22 may be dispersed between the upper substrate 10 and the lower substrate 20 to surround a peripheral area of the 3D curved display device, such that the display medium layer 16 is sealed by the sealant 22. Then, as shown in FIG. 1D, the molds 40 and 30 are removed to form the 3D curved display device 200. The 3D curved display device 200 has a curved shape substantially the same as that with the surface stereo-shapes of the molds 40 and 30. In addition, the surface stereo-shapes of the molds 40 and 30 and the curved shape of the 3D curved display device 200 can be a concave shape, a convex shape or a complex curved surface composed of concave and convex shapes.

Instead of the mold 40, the pressure source over the upper substrate 10 can also be provided alternatively by applying air pressure onto the upper substrate 10. The air pressure is about 0 to 10 atm. Moreover, a plurality of openings (not shown) passing through the mold 30 may be formed and then a vacuum-pumping process may be performed through the openings of the mold 30 to provide the pressure source.

In an embodiment, the plastic display panel 100 may further comprise a pair of alignment layers (not shown) individually disposed on an upper side and a lower side of the display medium layer 16 for sandwiching the display medium layer 16. Further, in an embodiment, before performing the molding process 50, a pair of polarizers (not shown) may be disposed on an upper side and a lower side of the plastic display panel 100 for sandwiching the plastic display panel 100. In an embodiment, before performing the molding process 50, a light reflective layer or a light absorbing layer (not shown) may be formed between the upper electrode layer 12 and the upper substrate 10 or between the lower electrode layer 18 and the lower substrate 20, depending on the display types of the 3D curved display device. The material of the light reflective layer or the light absorbing layer may be aluminum, aluminum oxide, titania, carbon black or other color pigment. Moreover, in an embodiment, after forming the 3D curved display device 200, a backlight (not shown) may be disposed on a side of the 3D curved display device 200.

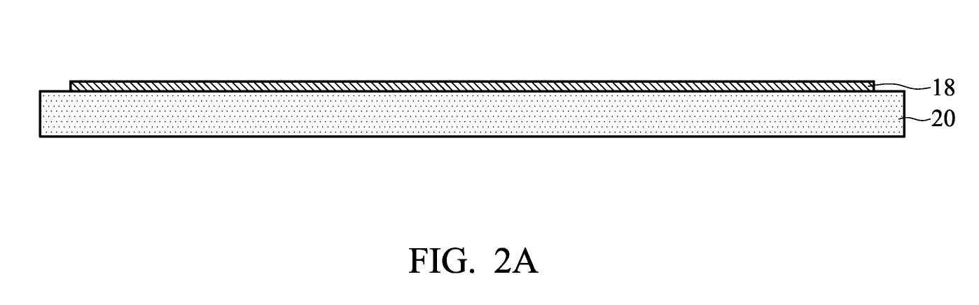

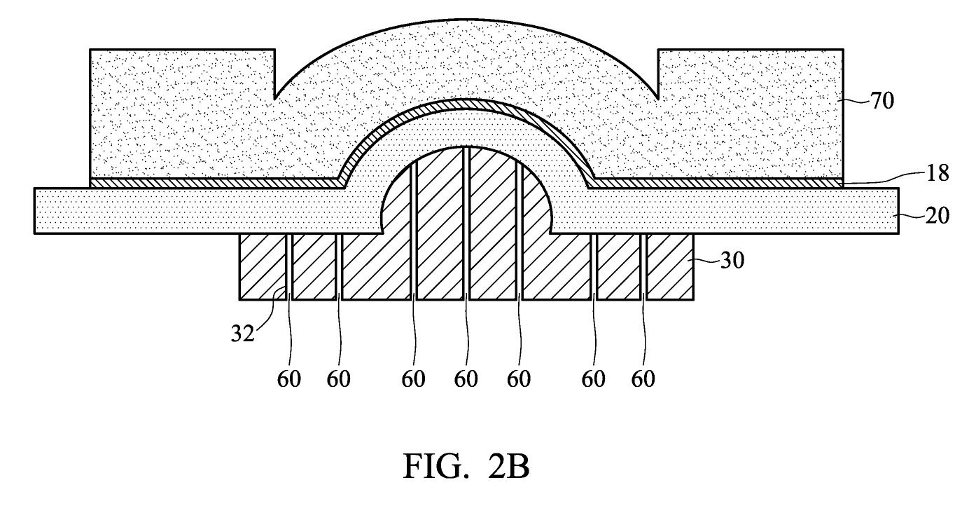

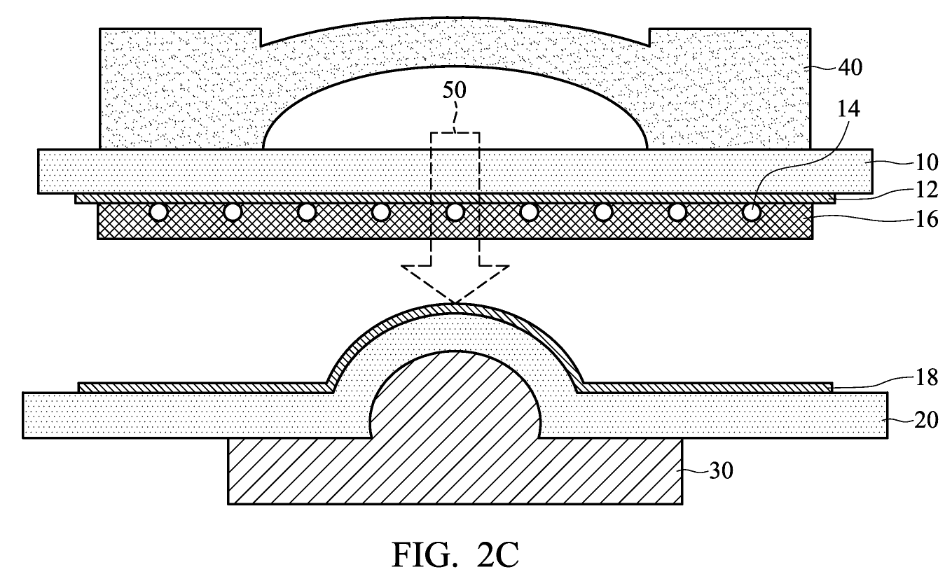

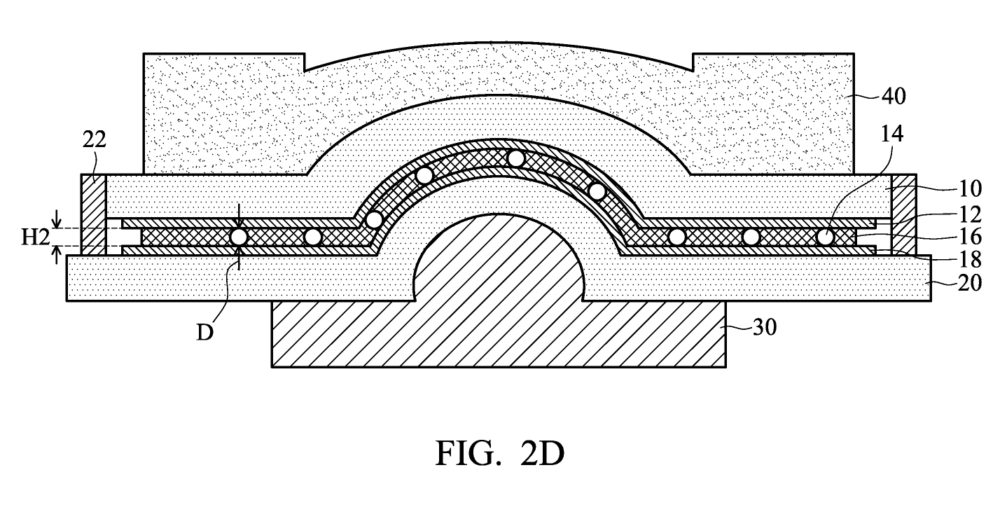

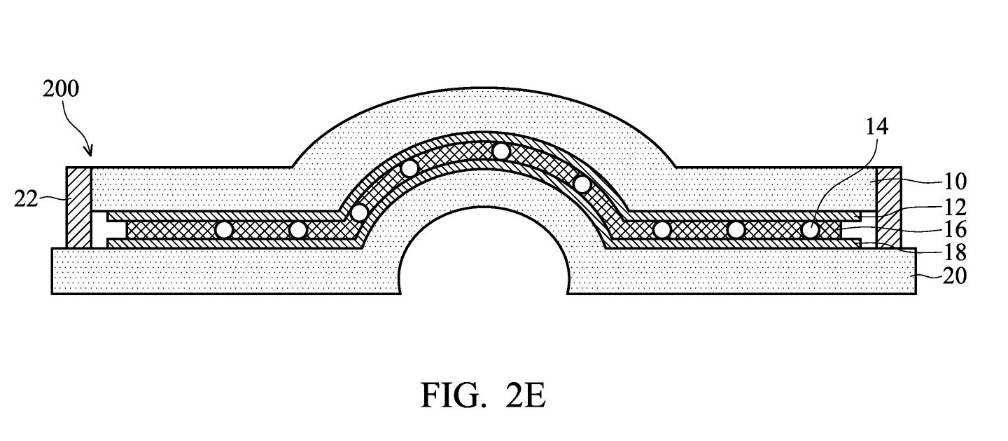

Referring to FIGS. 2A-2E, cross sections of a method for fabricating a 3D curved display device according to another embodiment of the invention are shown. As shown in FIG. 2A, first, a lower substrate 20 is provided and a lower electrode layer 18 is formed on the lower substrate 20. The materials of the lower substrate 20 and the lower electrode layer 18 can be selected from the above mentioned plastic or elastic materials.

Then, referring to FIG. 2B, a mold 70 and a mold 30 are provided and individually disposed over and under the lower substrate 20 for compressing the lower substrate 20 and the lower electrode layer 18 onto the mold 30 by a molding process. In an embodiment, the materials of the lower substrate 20 and the lower electrode layer 18 may be elastic materials. Moreover, during the molding process, a plurality of openings 32 of the mold 30 can be utilized to perform a vacuum-pumping process 60 or an adhesive may be used for fixing the lower substrate 20 and the lower electrode layer 18 onto the mold 30.

Next, referring to FIG. 2C, an upper substrate 10 is provided and an upper electrode layer 12 is formed on the upper substrate 10. Then, a plurality of spacers 14 and a display medium layer 16 are formed on the upper electrode layer 12. The display medium layer 16 has a thickness greater than a height of the spacers 14. The thickness of the display medium layer 16 is about 1.3 to 1.5 times the height of the spacers 14. In an embodiment, the materials of the upper substrate 10 and the upper electrode layer 12 can be selected from the above mentioned plastic or elastic materials.

A pressure source is provided over the upper substrate 10. Through a molding process 50 to control a temperature, a tension and a pressure suitable for the plastic display panel 100, the upper substrate 10, upper electrode layer 12, the spacers 14 and the display medium layer 16 are compressed with the lower electrode layer 18 on the mold 30 and the lower substrate 20 together. The pressure source can be provided from the mold 40 or from applying an air pressure over the upper substrate 10.

Then, referring to FIG. 2D, a 3D curved display device is formed between the mold 40 and the mold 30. The display medium layer 16 has a thickness substantially equal to the height of the spacers 14. After the molding process 50, the display medium layer 16 is cured for shaping by a heat curing process or a UV light curing process. In an embodiment, a sealant 22 may be formed at a peripheral area of the 3D curved display device to seal the display medium layer 16. Then, as shown in FIG. 2E, the molds 40 and 30 are removed to form the 3D curved display device 200. Moreover, the 3D curved display device 200 may further comprise a pair of alignment layers, a pair of polarizers, a light reflective layer or a light absorbing layer and/or a backlight disposed in the same way as the above mentioned embodiments.

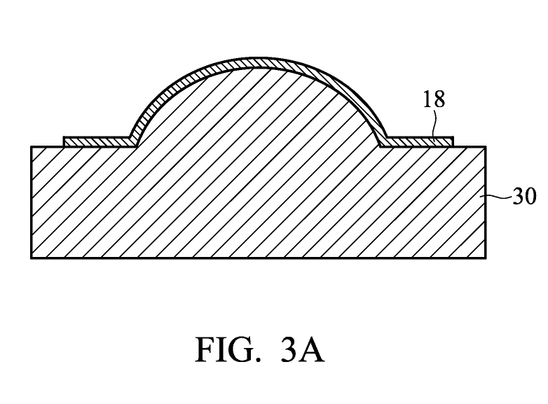

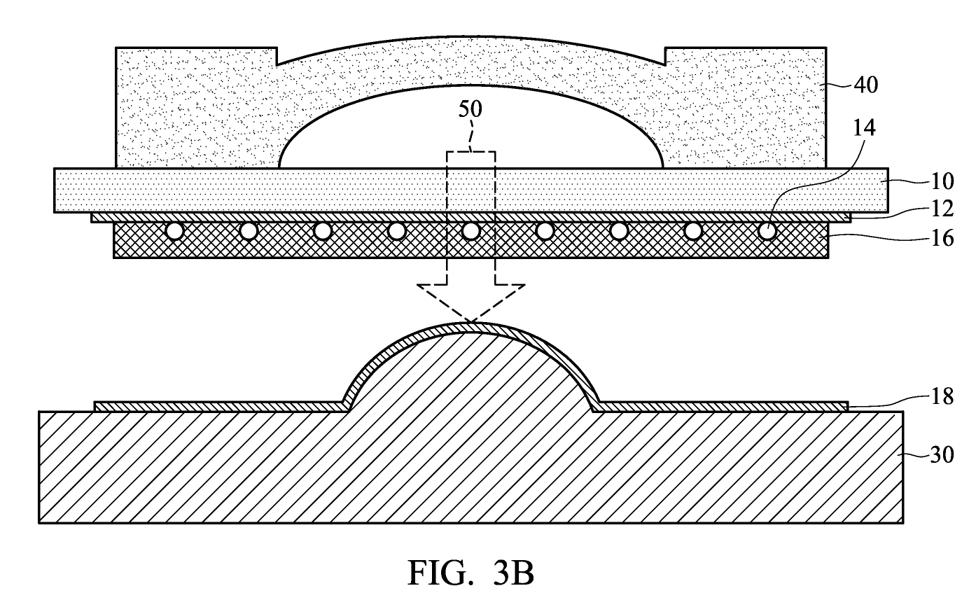

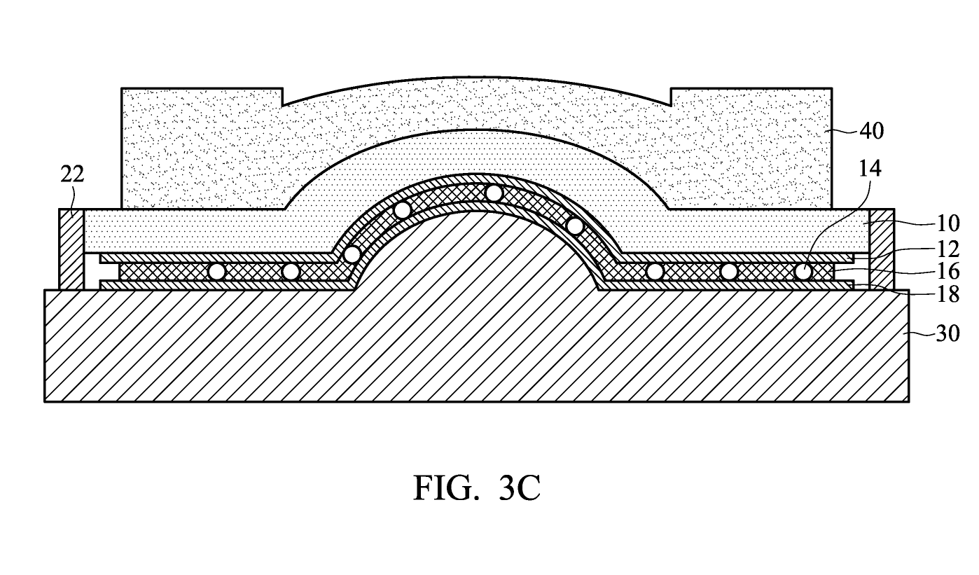

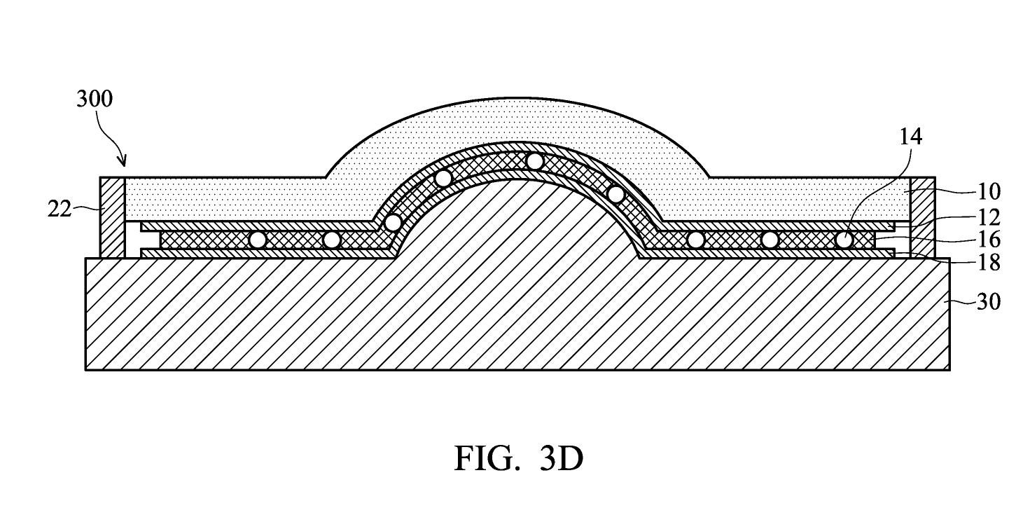

Referring to FIGS. 3A-3D, cross sections of a method for fabricating a 3D curved display device according to further another embodiment of the invention are shown. As shown in FIG. 3A, a mold 30 is provided and then a lower electrode layer 18 is formed on the mold 30. The lower electrode layer 18 may be a patterned electrode layer formed by a printing process or a laser patterning process. In an embodiment, the material of the lower electrode layer 18 can be selected from good conductive materials such as silver paste, aluminum, copper, indium tin oxide (ITO), poly(3,4-ethylene dioxythiophene) (PEDOT), polyaniline (PANI), polymers mixed with nano-carbon tubes (CNTs) or polymers mixed with metal fibers.

Next, referring to FIG. 3B, an upper substrate 10 is provided and an upper electrode layer 12 is formed on the upper substrate 10. Then, a plurality of spacers 14 and a display medium layer 16 are formed on the upper electrode layer 12. The display medium layer 16 has a thickness greater than a height of the spacers 14. The thickness of the display medium layer 16 is about 1.3 to 1.5 times the height of the spacers 14. In an embodiment, the materials of the upper substrate 10 and the upper electrode layer 12 can be selected from the above mentioned plastic materials.

A pressure source is provided over the upper substrate 10. Through a molding process 50 to control a temperature, a tension and a pressure suitable for the plastic display panel 100, the upper substrate 10, upper electrode layer 12, the spacers 14 and the display medium layer 16 are compressed with the lower electrode layer 18 on the mold 30. The pressure source can be provided from the mold 40 or applying an air pressure over the upper substrate 10, or performing a vacuum-pumping process on the lower electrode layer 18 through a plurality of openings of the mold 30.

Then, referring to FIG. 3C, after the molding process 50, a 3D curved display device is formed. The display medium layer 16 has a thickness substantially equal to the height of the spacers 14. After the molding process 50, the display medium layer 16 is cured for shaping by a heat curing process or a UV light curing process. In an embodiment, a sealant 22 may be formed at a peripheral area of the 3D curved display device to seal the display medium layer 16.

Next, referring to FIG. 3D, the mold 40 is removed to form a 3D curved display device 300. In this embodiment, the mold 30 is a portion of the 3D curved display device 300. Moreover, the 3D curved display device 300 may further comprise a pair of alignment layers, a pair of polarizers, a light reflective layer or a light absorbing layer and/or a backlight, wherein the upper polarizer is disposed over the upper substrate and the lower polarizer is disposed between the lower electrode layer 18 and the mold 30. The other elements of the 3D curved display device 300 are disposed in the same way as the above mentioned embodiments.

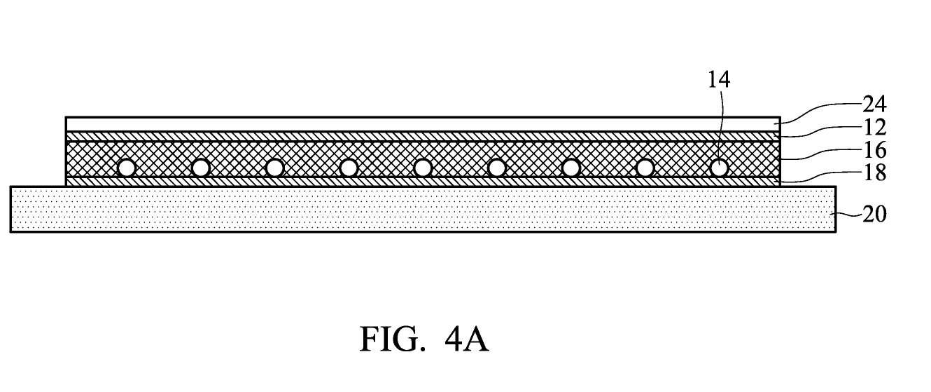

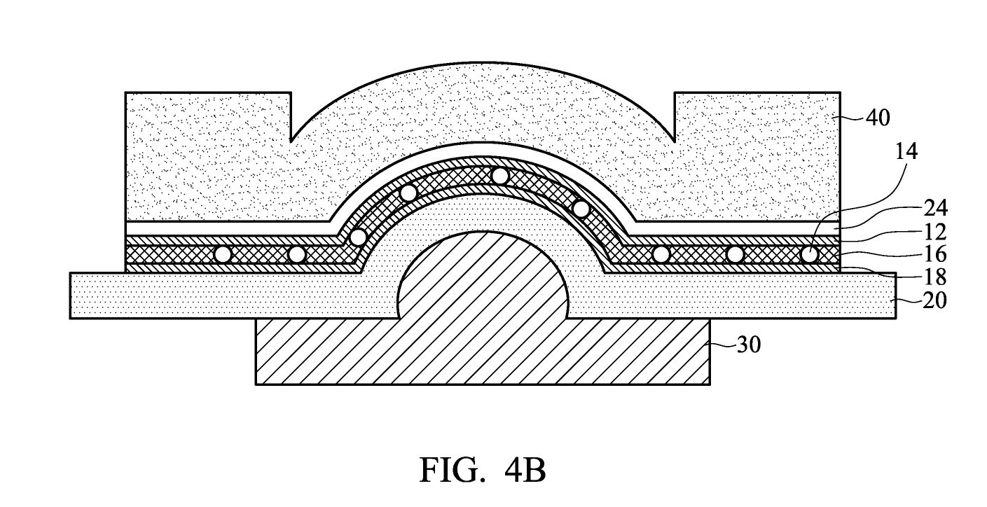

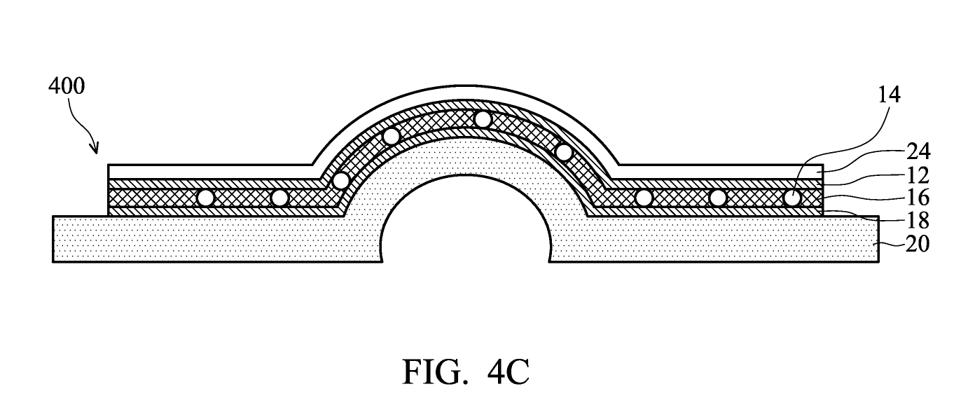

Referring to FIGS. 4A-4C, cross sections of a method for fabricating a 3D curved display device according to further another embodiment of the invention are shown. As shown in FIG. 4A, first, a lower substrate 20 is provided and a lower electrode layer 18 is formed on the lower substrate 20. Then, a plurality of spacers 14 and a display medium layer 16 are formed on the lower electrode layer 18. An upper electrode layer 12 is then formed on the display medium layer 16. In a preferred embodiment, a protective layer 24 is further formed on the upper electrode layer 12 to protect the upper electrode layer 12 and the display medium layer 16. In this embodiment, the materials of the lower substrate 20, the lower electrode layer 18 and the upper electrode layer 12 can be selected from the above mentioned plastic or elastic materials

Next, referring to FIG. 4B, a pressure source and a mold 30 are provided to sandwich the upper electrode layer 12 and the lower substrate 20. Through a molding process, the protective layer 24, the upper electrode layer 12, the spacers 14, the display medium layer 16, the lower electrode layer 18 and the lower substrate 20 are compressed together. The pressure source can be provided from a mold 40 or applying an air pressure over the upper electrode layer 12, or performing a vacuum-pumping process on the lower substrate 20 through a plurality of openings of the mold 30. Then, as shown in FIG. 4C, the molds 40 and 30 are removed to form a 3D curved display device 400.

In another embodiment, the lower substrate 20 as shown in FIG. 4A may face the mold 40 and the upper electrode layer 12 may face the mold 30 for performing the molding process to form a 3D curved display device. In this embodiment, no protective layer is required to form over the upper electrode layer 12. The lower substrate 20 is used as a protective layer of the 3D curved display device. Moreover, the 3D curved display device 400 may further comprise a pair of alignment layers, a pair of polarizers, a light reflective layer or a light absorbing layer and/or a backlight disposed in the same way as the above mentioned embodiments.

In the above mentioned embodiments, the mold 30 may or may not be removed, depending on actual application conditions. In addition, in the above mentioned embodiments, the descriptions of the upper and lower locations of the upper and the lower substrates are used to simplify and clearly describe the embodiments of the invention. Thus, the locations of the upper and the lower electrode layers and the locations of the upper and the lower substrates are not limited. In other embodiments, the display medium layers with different colors can be stacked into a multi-layered display medium layer to achieve colorful displays, wherein the adjacent display medium layers can share the upper and the lower substrates or the upper and the lower electrode layers. In these embodiments, the relative locations of the substrates and the electrode layers can be interchanged.

According to the embodiments of the invention, 3D curved display devices and fabrication methods thereof are provided. Moreover, plastic display panels are also provided, which can be applied to molds with various shapes for forming 3D curved display devices with various shapes.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended aims should be accorded the broadest interpretation so as to encompass all such modifications and similar arrangements.

What is claimed is:

1. A method for forming a 3D curved display device, comprising:
providing a first substrate;
forming a first electrode layer on the first substrate;
forming a plurality of spacers on the first electrode layer;
forming a display medium layer over the first substrate, covering the spacers and the first electrode layer;
forming a second electrode layer on the display medium layer;
providing a first mold and a pressure source to sandwich the first substrate to the second electrode layer; and
performing a molding process to compress the first substrate, the first electrode layer, the spacers, the display medium layer and the second electrode layer to form a 3D curved display device,
wherein the first substrate, the first electrode layer and the second electrode layer are made of plastic or elastic materials, and the display medium layer has a first thickness before the molding process, and the first thickness is greater than a height of the spacers.

2. The method as claimed in claim 1, further comprising providing a second substrate disposed on the second electrode layer before the molding process, wherein the second substrate comprises a plastic or elastic material.

3. The method as claimed in claim 2, wherein the first substrate, the first electrode layer, the spacers, the display medium layer, the second electrode layer and the second substrate are combined to form a plastic display panel before the molding process.

4. The method as claimed in claim 2, wherein the materials of the first substrate and the second substrate comprise poly(ethylene terephthalate) (PET), poly(ether sulfone) (PES), poly(ethylene 2,6-naphthalate) (PEN), poly carbonate (PC), polyimide (PI), poly(phenylene sulfone) (PPSU), natural rubber, silicone, or polyurethane (PU), or the derivatives thereof or combinations thereof.

5. The method as claimed in claim 1, wherein the materials of the first electrode layer and the second electrode layer comprise poly(3,4-ethylene dioxythiophene) (PEDOT), polyaniline (PANI), polymers mixed with nano-carbon tubes (CNTs) or polymers mixed with metal fibers.

6. The method as claimed in claim 1, wherein the step of providing the pressure source comprises providing a second model that compresses the second electrode layer or the first substrate, and performing a vacuum-pumping process on the second electrode layer or the first substrate through a plurality of openings of the first mold or providing air pressure to the second electrode layer or the first substrate.

7. The method as claimed in claim 1, wherein the display medium layer has a second thickness after the molding process, and the second thickness is equal to the height of the spacers.

8. The method as claimed in claim 1, wherein the first thickness is 1.3 to 1.5 times the height of the spacers.

9. The method as claimed in claim 1, wherein the first mold has a surface stereo-shape comprising a concave shape, a convex shape or a complex curved surface composed of concave and convex shapes.

10. The method as claimed in claim 1, wherein the display medium layer comprises a plastic material, comprising a plurality of display medium microcapsules and a plastic polymer filling between the display medium microcapsules, and the display medium microcapsules contain display media having variable optical states according to different driving schemes.

11. The method as claimed in claim 10, wherein the plastic polymer is a curable plastic polymer.

12. The method as claimed in claim 1, wherein the display medium layer comprises an electro-phoretic medium layer, a cholesteric liquid crystal medium layer, an electrowetting medium layer or a quick-response liquid power medium layer.

13. The method as claimed in claim 1, further comprising curing the display medium layer by a UV light curing process or a heat curing process after the molding process.

14. The method as claimed in claim 1, further comprising forming a thin film transistor array on the first substrate for electrical connection to the first electrode layer.

15. The method as claimed in claim 1, further comprising providing a backlight disposed on a side of the 3D curved display device.

16. The method as claimed in claim 1, wherein the step of forming the spacers comprises a spraying or a photolithography process.

17. The method as claimed in claim 1, further comprising forming a sealant at a peripheral area of the 3D curved display device to seal the display medium layer.

18. The method as claimed in claim 1, further comprising forming a light reflective layer or a light absorbing layer between the first substrate and the first electrode layer or on the second electrode layer.

19. A method for forming a 3D curved display device, comprising:
providing a first mold and forming a first electrode layer on the first mold;
providing a first substrate and forming a second electrode layer on the first substrate;
forming a plurality of spacers on the second electrode layer;
forming a display medium layer on the spacers and the second electrode layer;
providing a pressure source disposed over the first substrate; and
performing a molding process to compress the first substrate, the second electrode layer, the spacers, the display medium layer and the first electrode layer to form a 3D curved display device,
wherein the first substrate, the first electrode layer and the second electrode layer are made of plastic or elastic materials, and the display medium layer has a first thickness before the molding process, and the first thickness is greater than a height of the spacers.

20. The method as claimed in claim 19, further comprising providing a second substrate disposed between the first electrode layer and the first mold, and the second substrate and the first electrode layer are compressed and molded on the first mold before the molding process.

21. The method as claimed in claim 19, wherein the materials of the first electrode layer and the second electrode layer comprise poly(3,4-ethylene dioxythiophene) (PEDOT), polyaniline (PANI), polymers mixed with nano-carbon tubes (CNTs) or polymers mixed with metal fibers.

22. The method as claimed in claim 20, wherein the second substrate and the first electrode layer are elastic materials, and the step for compressing and molding the second substrate and the first electrode layer further comprises performing a vacuum-pumping process on the second substrate through a plurality of openings of the first mold or fixing the second substrate and the first electrode layer on the first mold by an adhesive.

23. The method as claimed in claim 19, wherein the first electrode layer is a patterned electrode layer directly formed on the first mold.

24. The method as claimed in claim 19, wherein the first thickness is 1.3 to 1.5 times the height of the spacers.

25. The method as claimed in claim 19, wherein the first mold has a surface stereo-shape comprising a concave shape, a convex shape or a complex curved surface composed of concave and convex shapes, and the 3D curved display device has a surface shape that is the same as the surface stereo-shape of the first mold.

26. The method as claimed in claim 19, wherein the display medium layer comprises a plastic material, comprising an electro-phoretic medium layer, a cholesteric liquid crystal medium layer, an electrowetting medium layer or a quick-response liquid power medium layer.

27. The method as claimed in claim 19, further comprising curing the display medium layer by a UV light curing process or a heat curing process after the molding process.

28. The method as claimed in claim 19, wherein the step of forming the spacers comprises a spraying or a photolithography process.

29. The method as claimed in claim 19, further comprising forming a sealant at a peripheral area of the 3D curved display device to seal the display medium layer.

30. The method as claimed in claim 19, further comprising forming a light reflective layer or a light absorbing layer between the first electrode layer and the first mold or between the first substrate and the second electrode layer.

31. The method as claimed in claim 19, further comprising providing a backlight disposed on a side of the 3D curved display device.

32. A 3D curved display device, comprising:
a first substrate;
a first electrode layer disposed on the first substrate;
a display medium layer disposed over the first electrode layer;
a plurality of spacers disposed in the display medium; and
a second electrode layer disposed on the display medium layer,
wherein the first substrate, the first electrode layer and the second electrode layer are made of plastic or elastic materials, and the display medium layer has a thickness equal to a height of the spacers.

33. The 3D curved display device as claimed in claim 32, further comprising a protective layer disposed on the second electrode layer.

34. The 3D curved display device as claimed in claim 32, further comprising a second substrate disposed on the second electrode layer, wherein the second substrate is a plastic or elastic material.

35. The 3D curved display device as claimed in claim 34, wherein the materials of the first substrate and the second substrate comprise poly(ethylene terephthalate) (PET), poly(ether sulfone) (PES), poly(ethylene 2,6-naphthalate) (PEN), poly carbonate (PC), polyimide (PI), poly(phenylene sulfone) (PPSU), natural rubber, silicone, or polyurethane (PU), or the derivatives thereof or combinations thereof.

36. The 3D curved display device as claimed in claim 32, wherein the materials of the first electrode layer and the second electrode layer comprise poly(3,4-ethylene dioxythiophene) (PEDOT), polyaniline (PANI), polymers mixed with nano-carbon tubes (CNTs) or polymers mixed with metal fibers.

37. The 3D curved display device as claimed in claim 32, further comprising a mold disposed under the second electrode layer as a portion of the 3D curved display device.

38. The 3D curved display device as claimed in claim 32, wherein the display medium layer comprises a plurality of display medium microcapsules dispersed in a polymer.

39. The 3D curved display device as claimed in claim 32, wherein the display medium layer comprises an electro-phoretic medium layer, a cholesteric liquid crystal medium layer, an electrowetting medium layer or a quick-response liquid power medium layer.

40. The 3D curved display device as claimed in claim 32, further comprising a sealant disposed at a peripheral area of the 3D curved display device to seal the display medium layer.

41. The 3D curved display device as claimed in claim 32, further comprising a light reflective layer or a light absorbing layer disposed on a side of the first electrode layer or the second electrode layer, opposite to the display medium layer.

42. The 3D curved display device as claimed in claim 32, further comprising a backlight disposed on a side of the 3D curved display device.

43. A plastic display panel, comprising;
a first substrate;
a first electrode layer disposed on the first substrate;
a plurality of spacers disposed on the first electrode layer;
a display medium layer disposed over the spacers and the first electrode layer;
a second electrode layer disposed on the display medium layer; and
wherein the first substrate, the first electrode layer and the second electrode layer are made of plastic or elastic materials, and the display medium layer has a thickness greater than a height of the spacers.

44. The plastic display panel as claimed in claim 43, wherein the materials of the first substrate comprise poly(ethylene terephthalate) (PET), poly(ether sulfone) (PES), poly(ethylene 2,6-naphthalate) (PEN), poly carbonate (PC), polyimide (PI), poly(phenylene sulfone) (PPSU), natural rubber, silicone, or polyurethane (PU), or the derivatives thereof or combinations thereof.

45. The plastic display panel as claimed in claim 43, wherein the materials of the first electrode layer and the second electrode layer comprise poly(3,4-ethylene dioxythiophene) (PEDOT), polyaniline (PANI), polymers mixed with nano-carbon tubes (CNTs) or polymers mixed with metal fibers.

46. The plastic display panel as claimed in claim 43, wherein the thickness is 1.3 to 1.5 times the height of the spacers.

47. The plastic display panel as claimed in claim 43, wherein the display medium layer comprises a plastic material, comprising a plurality of display medium microcapsules dispersed in a polymer.

48. The plastic display panel as claimed in claim 43, wherein the display medium layer comprises an electro-phoretic medium layer, a cholesteric liquid crystal medium layer, an electrowetting medium layer or a quick-response liquid power medium layer.

49. The plastic display panel as claimed in claim 43, wherein the display panel further comprises a second substrate or a protection layer on the second electrode layer.
